(19) United States
(12) Patent Application Publication
(10) Pub. No.: US 2007/0152002 A1
(43) Pub. Date: Jul. 5, 2007

(54) Articulating cooler caddy for tailgates

(76) Inventor: Robert Lee Dollar JR., Dunnellon, FL (US)

Correspondence Address: Douglas Wm. Massinger, Esq.;Massinger Law Offices, 887 N.E. 100 Street, Ocala, FL, 34479, US

(21) Appl. No.: 11/325,118

(22) Filed: Jan. 4, 2006

(51) Int. Cl. B60R 9/00; B60R 11/00; B60R 7/00

(52) U.S. Cl. 224/404; 224/553; 224/557; 224/926

(57) ABSTRACT

An articulating beverage cooler retention device for use in vehicles equipped with a tailgate is comprised generally of a carriage assembly capable of articulation about a horizontal axis, the carriage assembly including a base for receiving a cooler thereon, the base being fixedly attached to a substantially vertical support stanchion; mounting means for securing the carriage assembly to the top (when closed) of the tailgate; retention means for securing the cooler within the carriage assembly; and locking means for securing the support stanchion in an upright position (substantially perpendicular to the ground) when the tailgate is lowered to its horizontal open position.

### FIELD OF THE INVENTION

The subject invention relates generally to an accessory device for vehicles having a tailgate and to an articulating beverage cooler retention device therefore, in particular.

### BACKGROUND OF THE INVENTION

Portable beverage coolers such as the heavy-duty 5-gallon type produced by Igloo® Products, Inc., are popular among owners of utility vehicles and pick-up trucks having a cargo area suitable for their storage and transport. The traditional construction of a utility vehicle's cargo space or “bed” includes an area defined by a floor panel, three upright sidewalls, and a pivoting substantially rectangular tailgate. The tailgate may be of the swingout type in which case it is hingedly attached to a sidewall and pivots about a vertical axis, or may be of the fold-down type in which case its opposite ends are hingedly attached to the floor panel of the bed along a horizontal axis. In a fold-down tailgate arrangement, the inside surface of the tailgate faces the cargo space when the tailgate is in a closed upright position and extends substantially horizontally to the rear of the bed when, the tailgate is in an open position. The subject invention is an accessory device for utility vehicles having tailgates attached by either method, but has considerable advantages when used with the latter method as will become apparent upon further reference to this specification.

Heretofore, the storage and transportation of portable beverage coolers within the cargo area of pick-up trucks and the like has not been without complications. One problem is the propensity of the container to shift when exposed to the forces of a moving vehicle. Such movement can be moderate, resulting in the mere nuisance of having the container shift towards the front of the vehicle and therefore out of reach, or more severe, resulting in the overturning of the container and spillage of its contents.

Several U.S. Patents have been issued for carriers intended to restrict the movement of articles within a vehicle's cargo area. For instance, U.S. Pat. No. 3,765,635, entitled BRACKET FOR GAS CONTAINERS AND SIMILAR TANKS, discloses a support plate which may be bolted or screwed to a truck wall and a collar bolted to the support plate. The collar is made of two semicircular pieces, hinged together at one end. An upper flange of a tank may be placed within the collar and the pieces may be clamped together opposite the hinged ends, securing the tank. One shortcoming of this device is that it interferes with the use of the truck bed when not in use. The only way to recover the space occupied by the bracket is to unbolt it from the bed wall and remove it entirely.

Similarly, U.S. Patent No. 4,860, entitled MOUNTING RACK, teaches a water jug carrier for truck beds. The device is comprised of an attachment plate with a bracket that is bolted to a wall of the bed and several removable components attached to the bracket for retaining the jug in place. Here again, the components occupy a significant amount of space within the cargo area and the only way to recover the space is to leave the removable parts of the rack behind.

Based on the above, it is clear that it would be of benefit to have a portable beverage cooler retention device which does not occupy valuable cargo space. Accordingly, it has been found useful to mount the cooler outside the cargo space. U.S. Pat. No. 6,517,036 issued to Ramirez, Jr. teaches a water cooler holder capable of removable attachment to various regions of a pickup vehicle, including over a closed tailgate. In one embodiment, the Ramirez device is comprised of two parallel rings joined by support bars which hook over the side panel or tailgate of the truck bed. Unfortunately, this device suffers from various shortcomings and limitations. Perhaps the greatest of shortcoming is that tailgates of the fold-down type cannot be opened once the device is mounted thereon. Opening of the tailgate would necessarily cause the cooler to rotate from a substantially vertical axis to a horizontal one resulting in spillage of the cooler's contents and the cooler becoming unseated from the holder altogether. Moreover, the user is required to lift the container a considerable height into the holder once hung over the tailgate which can be a difficult task when the cooler is filled. Finally, the Ramirez holder is not secured to the tailgate other than through gravity and therefore is not suitable for stowage of the cooler during operation of the vehicle.

It is clear that a significant need exists for a cooler retention device for pickup trucks that: 1) may be mounted outside the vehicle's cargo area, 2) may be mounted on the vehicle's tailgate, 3) will not interfere with the ability to open the tailgate when mounted thereon, 4) may be secured to the vehicle in such a way that the cooler may remain in the device during vehicle use, and 5) obviates the need to lift the cooler a significant height above the ground for mounting purposes. None of the references described above, alone or in combination, teach a device having all of the above benefits and capabilities.

### SUMMARY OF THE INVENTION

The subject invention more specifically relates to an articulating beverage cooler retention device for use in vehicles equipped with a tailgate and is comprised generally of a carriage assembly capable of articulation about a horizontal axis, the carriage assembly including a base for receiving a cooler thereon, the base being fixedly attached to a substantially vertical support stanchion; mounting means for securing the carriage assembly to the top (when closed) of the tailgate; retention means for securing the cooler within the carriage assembly; and locking means for securing the support stanchion in an upright position (substantially perpendicular to the ground) when the tailgate is lowered to its horizontal open position.

Application of the subject cooler caddy to tailgates of the fold-down type manifest one of its primary advantages over the above described prior art, namely its ability to retain a beverage cooler in a substantially upright position regardless of whether the tailgate is in its closed (vertical) position, or in its open (horizontal) position. The articulating nature of the carriage assembly, therefore, obviates the need for removing the cooler and the device itself from the tailgate when access to the vehicle's cargo area is desired and the tailgate must be folded down. Moreover, when the tailgate is lowered to its open position, the carriage assembly is also lowered to a height which permits mounting of the cooler with ease and without lifting above the user's knees.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is, therefore, a primary object of the subject invention to provide a beverage cooler retention device for use in vehicles equipped with a swing-out or fold-down tailgate.

It is also a primary object of the subject beverage cooler caddy to provide a means for mounting a cooler outside the vehicle's cargo area generally, and to the exterior of the vehicle's tailgate, in particular.

Another primary object of the subject invention is to provide a tailgate mounted beverage cooler caddy which will not preclude opening of the tailgate nor first require that the caddy and cooler be removed there from.

It is still another primary object of the present invention to provide a tailgate mounted beverage cooler caddy that obviates the need to lift the cooler a significant height above the ground for mounting purposes.

Yet another object of the present invention is to provide a portable beverage cooler retention device which is relatively inexpensive to manufacture and thereby affordable to the average consumer of such products.

These together with other objects of the invention, along with the various features of novelty which characterize the invention, are pointed out with particularity in the claims annexed to and forming a part of this disclosure. For a better understanding of the invention, its advantages and the specific objects attained by its uses, reference should be had to the accompanying drawings and descriptive matter in which there is illustrated a preferred embodiment of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the subject beverage cooler caddy shown mounted on a vehicle's closed tailgate;

FIG. 2 is an enlarged perspective view of a portion of the carriage assembly of the invention of FIG. 1;

FIG. 3 is an enlarged perspective view of the mounting assembly, the pivotable support stanchion connected thereto, and locking means of the subject invention; and

FIG. 4 is a perspective view of the subject tailgate mounted beverage cooler caddy with the tailgate being shown in its lowered, open position.

### DETAILED DESCRIPTION OF THE PREFERRED EMBODIMENT

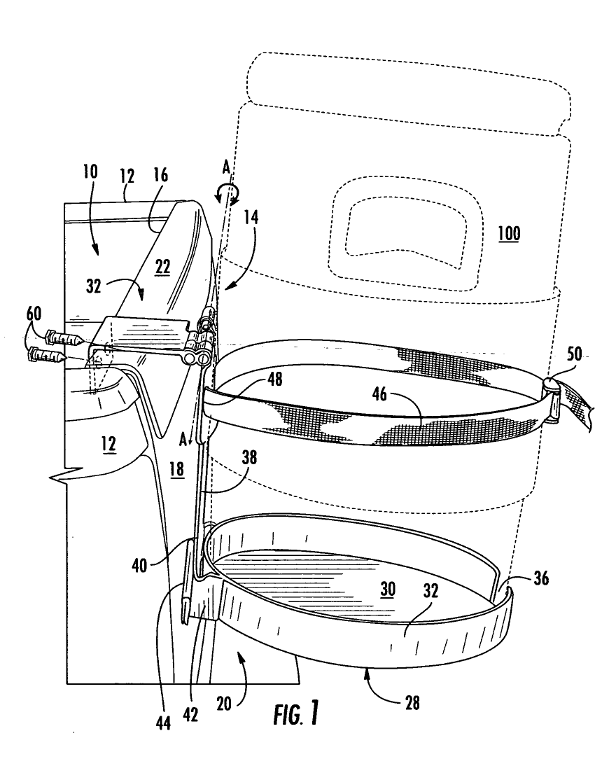

Reference is now made to FIG. 1 in which there is illustrated a perspective view of the subject beverage cooler caddy shown mounted on a vehicle having a fold-down type tailgate. It should be immediately understood that the subject invention may also be employed on vehicle's having a swing-out type tailgate although the greatest advantages of the subject device may be experienced when used in combination with the former type.

Before the objects and advantages of the subject invention can be fully appreciated, it is helpful to understand the general construction of a pickup truck's cargo area. To this end, the vehicle's cargo area 10 is an open space defined by a bed or floor panel (not visible in this Figure) situate in substantially horizontal orientation and having perpendicularly attached thereto two upright side walls 12 which are oriented in parallel relationship to one another along a vertical plane. A rear door (or “tailgate”) 14 connects the two side walls towards the rear of the vehicle. The forward portion of the cargo area may either be either closed (such as in the case of pickup trucks) or open (such as in the case of a Jeep®, for example).

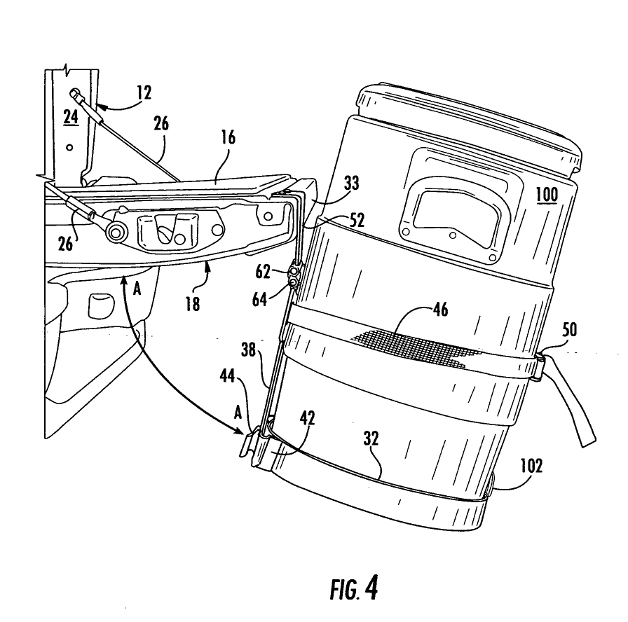

In the example illustrated in FIG. 1, tailgate 14 is of the fold-down tailgate type found in pickup trucks and includes interior surface 16, exterior surface 18, hinged edge 20 and free edge 22. Tailgate 14 is connected at both side edges to the interior panels 24 of sidewalls 12 by conventional hinges or other suitable coupling means. Attachment of tailgate 14 in this manner permits its pivotal rotation between open and closed positions. When closed (as shown), tailgate 14 occupies a substantially vertical plane and lies perpendicular to the floor panel. When open (FIG. 4), tailgate 14 is situate in a substantially horizontal orientation substantially coplanar with the floor panel and essentially forming a rearward extension thereof. Tailgate restraining means 26 (FIG. 4) are connected between each interior panel 24 and the sides of tailgate 14, and limit opening of the tailgate to the horizontal plane. Restraining means 26 are typically of the flexible cable type or are comprised of articulated linkage. As stated above, the fold-down tailgate 14 may be substituted with a swingout type rear door (not shown).

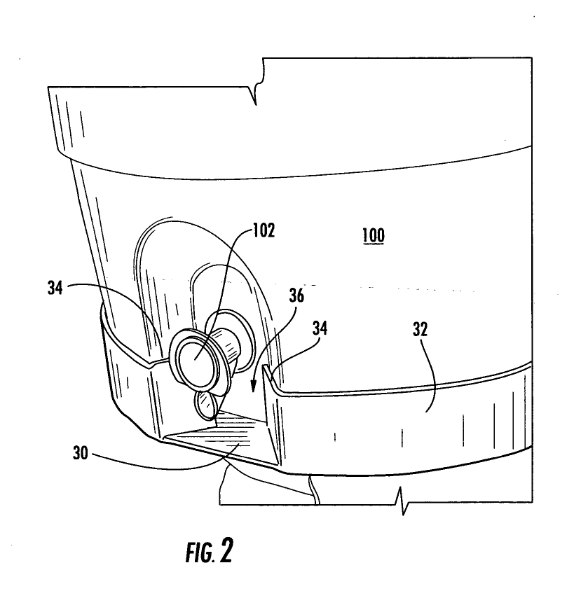

With continued reference to FIG. 1, the subject invention more specifically relates to a tailgate mounted articulating beverage cooler caddy for use in vehicles equipped with a cargo area 10 and is comprised generally of a cooler carriage assembly 28 capable of articulation about a horizontal axis A-A for purposes described herein. Carriage assembly 28 includes a circular base 30 for receiving a cooler 100 (shown in phantom view) thereon and is situate on a substantially horizontal plane. A retention wall 32 extends a distance vertically from base 30 and around its perimeter to add structural integrity to the carriage assembly generally. Retention wall 32 further provides a means for retaining the base of beverage cooler 100 in place when seated in carriage assembly 28 (see also FIG. 4). Referring to FIG. 2, note that a portion of retention wall 32 may optionally include detents 34 which are shaped to conform to a corresponding concave region of the Igloo® brand 5 gallon beverage cooler and prevent axial rotation of cooler 100 within carriage assembly 28. Detents 34 further form the outer margins of spout aperture 36 through which spout 102 of cooler 100 is positioned to facilitate access to the spout.

With continued reference to FIG. 1, carriage assembly 28 further includes rectangular upright support stanchion 38 having first end 40 which is fixedly mounted to base 30 and retaining wall 32. A pair of gussets 42 are fixedly attached in substantially perpendicular fashion to each side of support stanchion 38 and the exterior surface of retaining wall 32 at different points to add structural integrity to the stanchion/base point of connection. Bumper 44 is affixed to the opposite side of stanchion 38 and serves to protect the exterior surface 18 of tailgate 14 from damage.

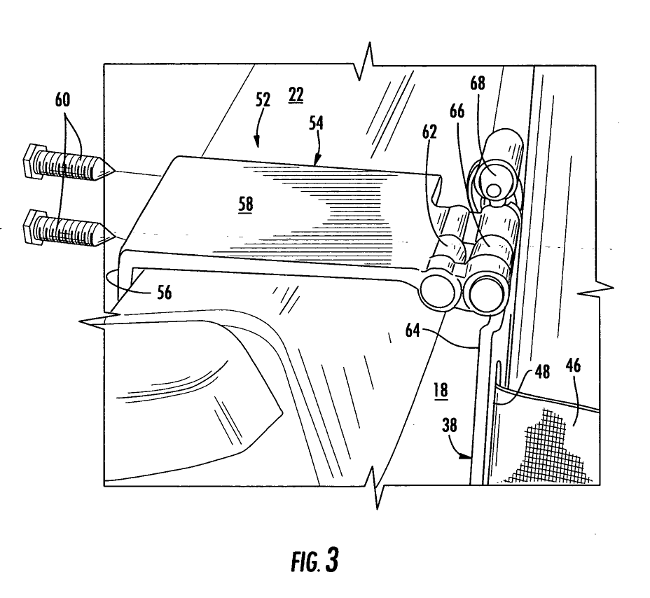

Carriage assembly 28 is also equipped with additional cooler retention means which, in the embodiment illustrated, is comprised of retention strap 46 threaded through a pair of longitudinal slots 48 (best illustrated in FIG. 3) in support stanchion 38. Retention strap 46 is secured around the midsection of cooler 100, preventing its movement, using closure means 50.

Referring now to FIG. 3, the subject invention further includes mounting means 52 for securing carriage assembly 28 to tailgate 14. Mounting means 52 is relatively simple in design and is comprised of rigid L-bracket 54 which in turn is comprised of first mounting plate 56 fixedly and perpendicularly attached to second mounting plate 58. L-bracket 54 is installed face down onto tailgate 14 such that first mounting plate 56 lies flush with the interior surface 16 of the tailgate and second mounting plate 58 lies flush with free edge 22 of the tailgate. Once positioned as described, mounting means 52 are secured to the tailgate using screws 60 or other suitable means. Second mounting plate 58 terminates at its opposite end in locking receiver 62 which is fixedly and transversely mounted thereto.

In order to permit carriage assembly 28 to pivot about axis A-A, the second end 64 of stanchion 38 is hingedly attached to mounting means 52 in general, and to locking receiver 62 in particular via hinge 66. Thusly configured, the subject beverage cooler caddy is capable of articulating about axis A-A as tailgate 14 is lowered from its upright closed position (FIG. 1) to its horizontal closed position (FIG. 4) to maintain cooler 100 in a relatively upright orientation. The articulating nature of the carriage assembly, therefore, obviates the need for removing the cooler and the device itself from the tailgate when access to the vehicle's cargo area is desired and the tailgate must be folded down. To secure carriage assembly 28 in this orientation, a spring loaded locking pin 68 fixedly attached to hinge 66 in parallel alignment is inserted into locking receiver 62 when rotated into axial alignment therewith. Together, locking receiver 62 and locking pin 68 comprise the locking means of the subject invention. It should be readily appreciated by those skilled in the art that alternative locking means may be employed to accomplish the intended result, the instant example being merely illustrative.

With continued reference to FIG. 4, it may be appreciated that base 30 of carriage assembly 28 lies in relatively close proximity to the ground when tailgate 14 is lowered to its open position. Cooler 100 may thus be mounted on base 30 with little effort and without lifting the cooler above the knees. Upon disengagement of locking pin 68 from locking receiver 62, closing of tailgate 14 will cause carriage assembly 28 to rotate again about axis A-A into place against exterior surface 18 of the tailgate. Regardless of whether tailgate 14 is in its open or closed position, spout 102 of cooler 100 is always accessible.

Although the present invention has been described with reference to the particular embodiments herein set forth, it is understood that the present disclosure has been made only by way of example and that numerous changes in details of construction may be resorted to without departing from the spirit and scope of the invention. Thus, the scope of the invention should not be limited by the foregoing specifications, but rather only by the scope of the claims appended hereto.

What is claimed as being new, useful and desired to be protected by Letters Patent of the United States is as follows:

1. An articulating beverage cooler retention device for use on vehicles equipped with a tailgate, the retention device comprising, 1) a support stanchion having a first end and a second end, 2) mounting means hingedly connected to said first end of said stanchion, said mounting means being capable of attachment to the top edge of the tailgate, 3) a carriage assembly having a base for receiving a cooler thereon, said base being fixedly and perpendicularly attached to said second end of said support stanchion; and 4) locking means fixedly attached to said hinge for releasibly locking said stanchion and said mounting means in substantially co-axial alignment.

2. The articulating beverage cooler retention device of claim 1, wherein said carriage assembly further includes cooler retention means for securing the cooler on said base of said carriage assembly.
